(19) United States
(12) Patent Application Publication
(10) Pub. No.: US 2025/0153961 A1
(43) Pub. Date: May 15, 2025

(54) INTELLIGENT LOADING AND UNLOADING INTEGRATED MACHINE

(71) Applicant: Shenzhen Robohorn Intelligent Equipment Co.,Ltd, Shenzhen (CN)

(72) Inventors: Licai Yuan, Shenzhen (CN); Changjin Tang, Shenzhen (CN); Sheng Chen, Shenzhen (CN); Tengfei Lei, Shenzhen (CN)

(21) Appl. No.: 19/023,639

(22) Filed: Jan. 16, 2025

(30) Foreign Application Priority Data
Nov. 1, 2024 (CN) 202411548511.7

(51) Int. Cl. B65G 67/20

(52) U.S. Cl. CPC B65G 67/20; B65G 2201/0235

(57) ABSTRACT

An intelligent loading and unloading integrated machine comprises a location identification module, a mobile platform, a motion group, a transport group and a visual identification component; the transport group comprises a transfer component and a receiving component; a transmission mechanism is arranged between the transfer component and the receiving component; the motion group comprises a first motion component, a second motion component, a third motion component and a fourth motion component; the first motion component comprises an adsorption component, a telescoping component, a rotating seat and a plurality of rotating shafts. The first motion component, the second motion component, the third motion component and the fourth motion component of the invention can grip a cargo flexibly and quickly; the visual identification component can identify the section of the cargo, and the receiving component can keep horizontal and receive the cargo with the shortest distance.

### TECHNICAL FIELD

The invention relates to the technical field of loading and unloading machinery, in particular to an intelligent loading and unloading integrated machine.

### BACKGROUND ART

Currently, cargoes are handled manually from the dock van truck, which not only has low working efficiency, but also causes great loss to the physical strength of the workers. Meanwhile, the environment of the dock is relatively harsh, which easily affects human health. Therefore, intelligent equipment is urgently needed to replace traditional manual handling.

The integrated loading and unloading machine and the automatic container loading and unloading system are disclosed in the prior art, wherein the first lifting guide rail, the second travelling rail and the second lifting guide rail are arranged in the height direction; the opposite travelling structure is arranged between the straining beam and the beam seat to adapt to the position of the cargoes at different heights and depths. Although this method can replace manual handling of cargoes, it has low flexibility, flexible movement cannot be realized at multiple angles or in multiple directions in the small space such as container or wagon box, and multiple work procedures are required to reach the target location of cargoes for loading or unloading, so that the degree of intelligence and the working efficiency are low.

### SUMMARY OF THE INVENTION

The invention aims to solve the technical problems of poor flexibility and low working efficiency in cargo loading and unloading in a small space in the prior art. Aiming at the above deficiencies of the prior art, the invention provides an intelligent loading and unloading integrated machine.

The invention adopts the following technical proposal to solve the technical problems:
an intelligent loading and unloading integrated machine comprises a location identification module for identifying container locations, a mobile platform, a motion group, a transport group and a visual identification component for identifying cargo information, the location identification module, the motion group and the transport group are respectively arranged on the mobile platform, and the visual identification component is arranged on one side of the motion group; the motion group and the transport group work together to take or receive materials; the transport group comprises a transfer component and a receiving component; a transmission mechanism is arranged between the transfer component and the receiving component to keep the receiving component in a horizontal state; the motion group comprises a first motion component, a second motion component, a third motion component and a fourth motion component for maintaining a constant distance between the front end of the receiving component and the cargo, and the first motion component, the second motion component, the third motion component and the fourth motion component are linked for gripping the cargo; the first motion component is arranged on one side of the transport group; the second motion component is fixedly connected with the first motion component, and drives the first motion component to move; the third motion component is fixedly connected with the second motion component, and drives the second motion component to move; the fourth motion component is located below the transport group and drives the transport group to move; the first motion component comprises an adsorption component, a telescoping component, a rotating seat and a plurality of rotating shafts, and the adsorption component is arranged at one end of the rotating shaft; the telescoping component is detachably connected with the adsorption component; the rotating seat is arranged on the second motion component; the rotating shafts is movably arranged between the rotating seat and the adsorption component.

Further, the intelligent loading and unloading integrated machine comprises a loading mode and an unloading mode; in the loading mode, the telescoping component is arranged on both sides of the adsorption component and works with the adsorption component to push the cargo; in the unloading mode, the adsorption component works with the first motion component to grip the cargo onto the transport group.

Further, the transfer component is linked with the fourth motion component, and is connected with the receiving component through the transmission mechanism; the transfer component is inclined or horizontally arranged above the fourth motion component; the receiving component is arranged horizontally at the front end of the inclined component; the transfer component comprises a first transfer belt, and the fourth motion component comprises a driving rod, one end of the driving rod is connected with the mobile platform, and the other end thereof is connected with the first transfer belt and drives the first transfer belt to move.

Further, the receiving component comprises a frame body, a wireless detector, a plurality of rolling rods and a second transfer belt, and the rolling rods and the second transfer belt are arranged respectively on the frame body; the second transfer belt is arranged at the front end of the first transfer belt and has the same motion direction as the first transfer belt; the wireless detector is fixedly arranged on one side of the frame body for detecting the cargo; the rolling direction of the rolling rods is perpendicular to the second transfer belt.

Further, in the unloading mode, the rolling rods rotate toward the second transfer belt, the second transfer belt drives toward the first transfer belt, and the first transfer belt has the same driving direction as the second transfer belt; in the loading mode, the first transfer belt drives toward the second transfer belt, the second transfer belt has the same driving direction as the first transfer belt, and the rolling rods rotate in the direction relative to the second transfer belt.

Further, the visual identification component comprises an image capture component for obtaining the section information of the cargo, an light identification instrument for identifying the external light intensity, a light source controller, a fixing rod, a deflection shaft, a first driving component and a plurality of light sources, and the first motion component comprises a motion controller; the light identification instrument is arranged on one side of the image capture component; the light sources are respectively arranged above the mobile platform; the light identification instrument and the light sources are electrically connected with the light source controller; the image capture component is electrically connected with the motion controller; the fixing rod is fixedly arranged above the second motion component, and the first driving component is fixedly arranged on the fixing rod; the image capture component is fixedly arranged on the deflection shaft, and a driving part of the first driving component is fixedly connected with the deflection shaft and drives the deflection shaft and the image capture component to deflect.

Further, the second motion component comprises a lifting shaft, a first transmission component, a carrier rack and a plurality of first guide rails, and the rotating seat is arranged on the carrier rack; the first transmission component is fixedly connected with the carrier rack and is connected with the lifting shaft in a driving way to drive the rotating seat to move; the lifting shaft and the first guide rail are vertically placed above the third motion component and are fixedly connected with the third motion component; the carrier rack is provided with a sliding block corresponding to the first guide rail, and the sliding block is connected with the first guide rail in a sliding way; the first transmission component drives together with the lifting shaft, and drives the sliding block to slide along the first guide rail.

Further, the third motion component comprises a telescopic shaft, a second transmission component and a plurality of second guide rails, the telescopic shaft and the second guide rails are respectively arranged under the lifting shaft, the second guide rails are fixedly arranged on both sides of the telescopic shaft; the second transmission component is fixedly connected with the carrier rack and has a driving relation with the telescopic shaft to drive the second motion component and the first motion component to move along the second guide rail.

Further, the telescoping component comprises a plurality of telescoping plates and a second driving component, the telescoping plates are symmetrically arranged on both sides of the adsorption component, the second driving component and the telescoping plates are arranged correspondingly.

Further, the adsorption component comprises a plate body and a plurality of adsorption parts, the plate body is rotationally connected with the rotating shaft, and the adsorption parts are arranged and distributed on a first surface of the plate body.

Further, a plurality of distance measuring components are fixedly arranged on a second surface of the plate body, the plate body is also provided with gaps, and the distance measuring components are respectively arranged towards the gaps.

The invention has the following beneficial effects: the location identification module identifies the location of the wagon box or container, the mobile platform automatically navigates to the entrance of the wagon box or container, and then the motion group and the transport group work together to take or receive materials. During unloading, the visual identification component identifies the cargo and controls the movement of the first motion component, the second motion component, the third motion component and the fourth motion component to achieve the multi-shaft linkage and the purpose of automatically gripping the cargo, the gripped cargo can be placed on the receiving component; as the receiving component is arranged horizontally and the distance between the receiving component and the cargo is constant, the receiving component can transport the cargo efficiently and prevent the cargo from falling height and being damaged. During loading, by the transfer component transports the cargo, the visual identification component judges the position of the cargo, the first motion component, the second motion component, the third motion component, the fourth motion component, the adsorption component and the telescoping component work together to push the cargo into the wagon box.

On the basis of the first motion component, the second motion component, the third motion component and the fourth motion component are added to form an unloading or loading mechanical arm, which can grip the cargo flexibly and quickly, and the receiving component and the transfer component reach the designated position through the fourth motion component and maintain a constant distance from the cargo to receive and transport the cargo efficiently, not only replacing the traditional manual handling, but also flexibly moving in a small space and gripping the cargo in a multi-posture way; at the same time, the visual identification component can identify the section of the cargo to quickly obtain the size and location information of the cargo, quickly and accurately loading or unloading the cargo, being more intelligent and greatly improving the working efficiency.

### BRIEF DESCRIPTION OF THE DRAWINGS

FIG. 1 is the overall structure diagram of an intelligent loading and unloading integrated machine in an embodiment of the invention.

FIG. 2 is the stereogram of an intelligent loading and unloading integrated machine in an embodiment of the invention from another angle.

FIG. 3 is the stereogram of an adsorption component and a telescoping component in an embodiment of the invention.

FIG. 4 is the stereogram of an intelligent loading and unloading integrated machine in an embodiment of the invention from another angle.

FIG. 5 is the cross-section diagram of a receiving component in an embodiment of the invention.

FIG. 6 is the stereogram of a second motion component in an embodiment of the invention.

FIG. 7 is the partial enlarged view of point I in FIG. 6 of the invention.

FIG. 8 is the stereogram of a third motion component in an embodiment of the invention.

FIG. 9 is the stereogram of a visual identification component in an embodiment of the invention.

FIG. 10 is the partial enlarged view of point Q in FIG. 9 of the invention.

FIG. 11 is the stereogram of a telescoping component in the invention.

Reference signs: location identification module 10, mobile platform 20, motion group 30, transport group 40, visual identification component 50, first motion component 310, second motion component 320, third motion component 330, fourth motion component 340, adsorption component 311, telescoping component 312, rotating seat 313, rotating shaft 314, transfer component 301, receiving component 302, transmission mechanism 401, first transfer belt 303, driving rod 341, frame body 304, wireless detector 305, rolling rod 306, second transfer belt 307, lifting shaft 321, first transmission component 322, carrier rack 323, first guide rail 324, sliding block 325, telescopic shaft 331, second transmission component 332, second guide rail 333, fixing rod 501, image capture component 502, first driving component 504, light identification instrument 505, light source 506, telescoping plate 315, second driving component 316, plate body 317, adsorption component 318, distance measuring component 319, gap 300.

### DETAILED DESCRIPTION OF THE INVENTION

To make the purpose, technical proposal and advantages of the invention clearer, the invention is further described below in detail in combination with the drawings and embodiments. It should be understood that the embodiments described herein are intended only to explain the invention, but not intended to limit it.

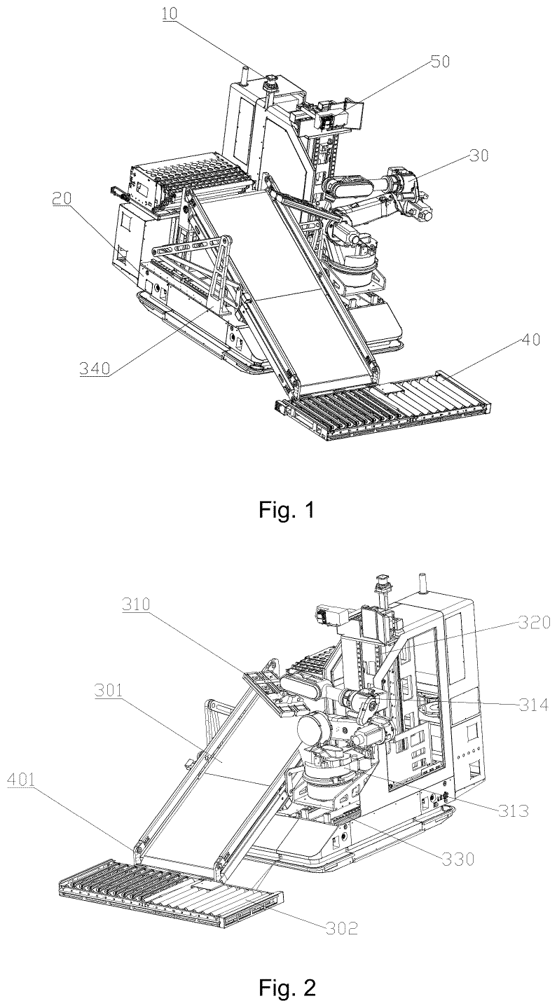

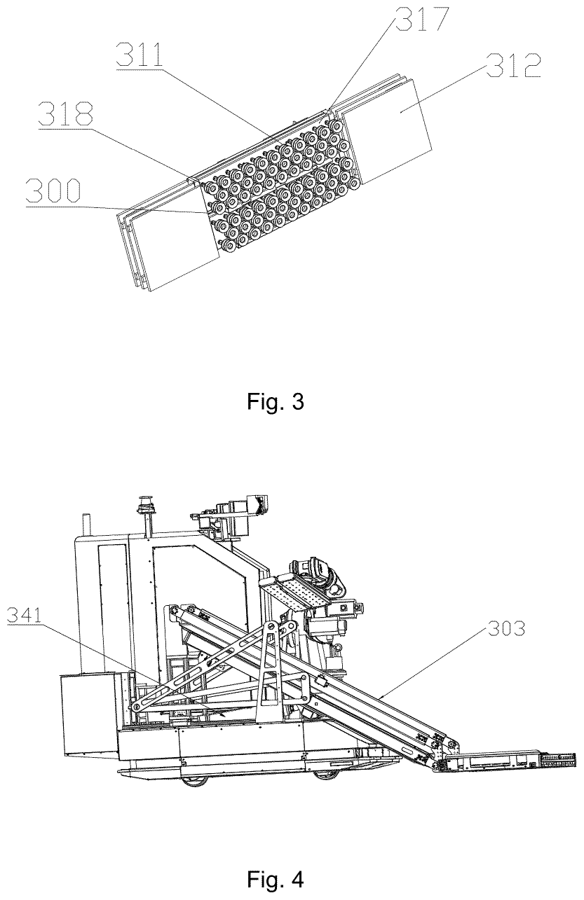

As shown in FIG. 1 and FIG. 2, the invention provides an integrated intelligent loading and unloading machine, which comprises a location identification module 10 for identifying container locations, a mobile platform 20, a motion group 30, a transport group 40 and a visual identification component 50 for identifying cargo information, the location identification module 10, the motion group 30 and the transport group 40 are respectively arranged on the mobile platform 20, and the visual identification component 50 is arranged on one side of the motion group 30; the motion group 30 and the transport group 40 work together to take or receive materials; the transport group 40 comprises a transfer component 301 and a receiving component 302; a transmission mechanism 401 is arranged between the transfer component 301 and the receiving component 302 to keep the receiving component 302 in a horizontal state; the motion group 30 comprises a first motion component 310, a second motion component 320, a third motion component 330 and a fourth motion component 340 for maintaining a constant distance between the front end of the receiving component 302 and the cargo, and the first motion component 310, the second motion component 320, the third motion component 330 and the fourth motion component 340 are linked for gripping the cargo; the first motion component 310 is arranged on one side of the transport group 40; the second motion component 320 is fixedly connected with the first motion component 310, and drives the first motion component 310 to move; the third motion component 330 is fixedly connected with the second motion component 320, and drives the second motion component 320 to move; the fourth motion component 340 is located below the transport group 40 and drives the transport group 40 to move; as shown in FIG. 3, the first motion component 310 comprises an adsorption component 311, a telescoping component 312 for pushing the cargo, a rotating seat 313 and a plurality of rotating shafts 314, the adsorption component 311 is movably arranged at the front end of the rotating shaft 31, and the telescoping component 312 is detachably connected with the adsorption component 311; the rotating seat 313 is arranged on the second motion component 320; the rotating shafts 314 is movably arranged between the rotating seat 313 and the adsorption component 311.

In the embodiment, the location identification module 10 is a radar for identifying the location of the carriage or container; the mobile platform 20 is an AGV omnidirectional motion platform, wherein AGV is short for Automated Guided Vehicle, which can automatically drive to a designated place according to a predetermined route. Specifically, the location identification module 10 is electrically connected with the mobile platform 20; after the location identification module 10 identifies the location of the carriage or container entrance, the external control system controls the mobile platform 20 to automatically navigate to the working position, namely, the carriage or container entrance. The motion group 30 grips the cargo by means of multi-shaft transmission, and works with the transport group 40 to take or receive materials. As shown in FIG. 2, specifically, the motion group 30 comprises a first motion component 310, a second motion component 320, a third motion component 330 and a fourth motion component 340, and the first motion component 310, the second motion component 320, the third motion component 330 and the fourth motion component 340 are linked and grip the cargo; the first motion component 310 comprises a rotating seat 313 and a plurality of rotating shafts 314, the rotating seat 313 is rotationally arranged above the second motion component 320, a plurality of rotating shafts 314 are rotationally arranged between the rotating seat 313 and the adsorption component 311, so that the adsorption component 311 can rotate at multiple angles and move in multiple directions; the second motion component 320 can drive the first motion component 310 to move in the vertical direction, the third motion component 330 can drive the first motion component 310 to move in the horizontal direction, and the fourth motion component 340 is arranged at the bottom of the transport group 40 and drives the transport group 40 to move to adapt to cargo loading and unloading at different heights. In one embodiment, the first motion component 310 is a 6-axis robot capable of moving in six axial directions, the second motion component 320, the third motion component 330, and the fourth motion component 340 are three external axial motion components, the first motion component 310, the second motion component 320, the third motion component 330 and the fourth motion component 340 forms a 9-axis linkage control, can move in nine axial directions to achieve the purpose of automatic gripping the cargo at high flexibility, and can quickly grip the cargo in the specified position. In another embodiment, the first motion component 310, the second motion component 320, the third motion component 330 and the fourth motion component 340 form an unloading mechanical arm, which is installed on the AGV omnidirectional motion platform, realizing flexible movement in a small space, such as container or wagon box, gripping in multiple postures quickly, and improving the working efficiency.

The transport group 40 comprises a transfer component 301 and a receiving component 302, and a transmission mechanism 401 is arranged between the transfer component 301 and the receiving component 302 and is capable of keeping the receiving component 302 in a horizontal state; specifically, a gap is generated between the transfer component 301 and the receiving component 302 and the cargo during the lifting process; when the receiving component 302 is in the horizontal state, the distance between the receiving component 302 and the cargo is shortest, and the receiving component 302 is closest to the cargo; in the invention, a compensation mechanism is provided, i.e. a constant distance is set, indicating that the receiving component 302 reaches the specified position; the receiving component 302 can be maintained in a horizontal state through the transmission mechanism 401, and moves to a constant distance between the receiving component 302 and the cargo through the fourth motion component 340; wherein, the transmission mechanism 401 can be a connecting rod mechanism or a crank rocker mechanism. the receiving component 302 moves to a constant distance between the receiving component 302 and the cargo through the fourth motion component 340, and keeps horizontal through the transmission mechanism 401, reducing the distance between the cargo and the receiving component 302, being more efficient and preventing the cargo from falling from a height and being damaged.

Specifically, before unloading, the unloading preparation is carried out so that the motion group 30 and the transport group 40 return to the initial working positions respectively. During unloading, the location identification module 10 identifies the location of the wagon box, the mobile platform 20 automatically navigates to the unloading working position, namely, the entrance of the wagon box or container, the visual identification component 50 identifies the cargo to obtain the cargo information and then controls the first motion component 310, the second motion component 320, the third motion component 330 and the fourth motion component 340 to move to the cargo position, the adsorption component 311 grips the cargo and places the cargo on the transport group 40, and finally the transport group 40 transports the cargo to a warehouse or palletizing position; the procedure is repeated until the unloading is completed. The first motion component 310, the second motion component 320, the third motion component 330, the fourth motion component 340 and the transport group 40 work together, greatly improving the working efficiency, up to 1200 pieces of cargo per hour.

Specifically, before loading, the motion group 30 and the transport group 40 respectively return to the initial working positions. First, the location identification module 10 identifies the location of the wagon box, then the mobile platform 20 automatically navigates to the loading position, the transport group 40 transports the cargo, during which the visual identification component 50 identifies the position of the cargo, the first motion component 310 stacks the cargoes, the telescoping component 312 and the adsorption component 311 work together to push the cargoes into the container after the cargoes are lined up.

In one embodiment, the intelligent loading and unloading integrated machine comprises a loading mode and an unloading mode; in the loading mode, the telescoping component 312 is arranged on both sides of the adsorption component 311 and works with the adsorption component 311 to push the cargo; in the unloading mode, the adsorption component 311 works with the first motion component 310 to grip the cargo onto the transport group 40.

Specifically, as shown in FIG. 3, in the loading mode, the telescoping component 312 is installed on both sides of the adsorption component 311, the transport group 40 judges whether the cargo arrives at the specified position, then the visual identification component 50 judges whether the cargoes are lined up, and the first motion component 310 works with the adsorption component 311 and the telescoping component 312 to push the cargo into the wagon box. During the period, the visual identification component 50 records the section of the cargo and sends the section information to the first motion component 310, and then the first motion component 310 moves according to the section information to prevent the collision between the cargoes.

As shown in FIG. 2, the transfer component 301 is linked with the fourth motion component 340 and is connected to the receiving component 302 through the transmission mechanism 401 in a transmission way; the transfer component 301 is inclined or horizontally arranged above the fourth motion component 340; the receiving component 302 is horizontally arranged at the front end of the transfer component 301.

In the specific implementation, the transfer component 301 linked above the fourth motion component 340, and is connected with the receiving component 302 through the transmission mechanism 401 in a transmission way. When the fourth motion component 340 is driven, the transfer component 301 and the receiving component 302 can be driven to move to adapt to the cargo loading and unloading at different heights. In one embodiment, after the adsorption component 311 grips the cargo, the transfer component 301 and the receiving component 302 are raised through the fourth motion component 340, the adsorption component 311 places the gripped cargo on the receiving component 302, the receiving component 302 transports the cargo to the transfer component 301 and finally transports warehouse or palletizing position; the fourth motion component 340 can adjust the height of the transport group 40, shorten the placing distance of the cargo, better receiving and transporting the cargo, and avoid damage caused by falling from the height. At the same time, the cargo can be quickly placed on the transport group 40 after adsorption, shortening the transportation time of the cargo and improving the working efficiency. Similarly, during loading, the transport group 40 is moved to the designated position through the fourth motion component 340, and the cargo is pushed into the wagon box through the first motion component 310, the telescoping component 312 and adsorption component 311 to quickly complete loading in the entire container or wagon box.

As shown in FIG. 4, the transfer component 301 comprises a first transfer belt 303; the fourth motion component 340 comprises a driving rod 341, one end of which is connected with the mobile platform 20 and the other end of which is connected with the first transfer belt 303 and drives the first transfer belt 303 to move.

In the specific implementation, one end of the driving rod 341 is connected with the mobile platform 20, and the other end thereof is connected with the first transfer belt 303; when the driving rod 341 provided for the fourth motion component 340 is driven for movement, the first transfer belt 303 is raised or lowered.

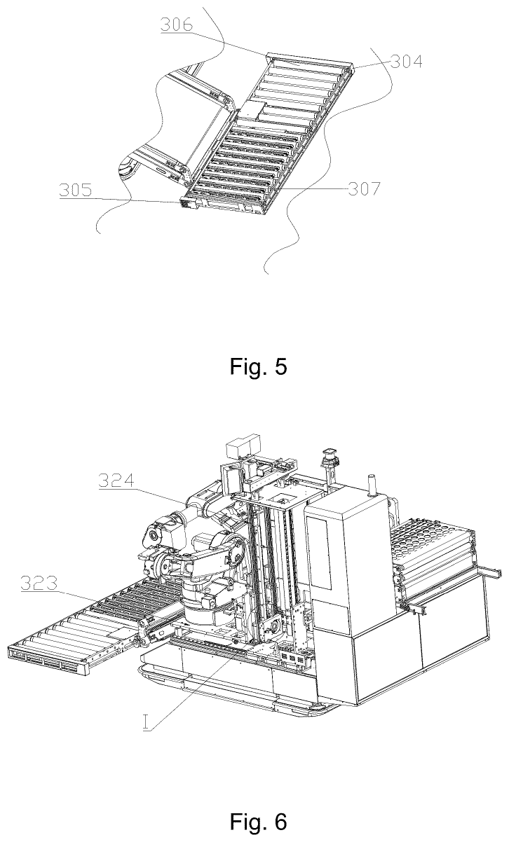

As shown in FIG. 5, the receiving component 302 comprises a frame body 304, a wireless detector 305, a plurality of rolling rods 306 and a second transfer belt 307, and the rolling rods 306 and the second transfer belt 307 are respectively arranged on the frame body 304; the second transfer belt 307 is arranged at the front end of the first transfer belt 303 and has the same motion direction as the first transfer belt 303; the wireless detector 305 is fixedly arranged on one side of the frame body 304 for detecting the cargo; the rolling direction of the rolling rods 306 is perpendicular to the second transfer belt 307.

In the specific implementation, the wireless detector 305 is arranged on one side of the receiving component 302. In one embodiment, the wireless detector 305 is a laser radar; during unloading, the laser radar checks whether there is cargo on the receiving component 302; if any, the cargo is transported to avoid cargo accumulation. During loading, the laser radar judges whether the cargo has been placed on the receiving component 302, facilitating to line up the cargoes.

During loading, the cargoes are transported from the first transfer belt 303 to the receiving component 302, lined up by the receiving component 302 and then pushed into the wagon box by the telescoping component 312 and the adsorption component 311; during unloading, the adsorption component 311 grips and places the cargoes on the receiving component 302, the receiving component 302 transports the cargoes to the first transfer belt 303, and finally transports the cargoes to the warehouse or palletizing position.

Further, the rolling rods 306 and the second transfer belt 307 are arranged respectively on the frame body 304, and the movement direction of the rolling rod 306 is perpendicular to the movement direction of the second transfer belt 307. During the adsorption component 311 places the cargoes on the rolling rods 306, the rolling rods 306 roll towards the second transfer belt 307, and the cargoes are driven by a plurality of rolling rods 306 to move toward the second transfer belt 307, and the second transfer belt 307 drives towards the first transfer belt 303; when being located above the second transfer belt 307, the cargoes are transferred to the first transfer belt 303 under the action of the second transfer belt 307, and then the first transfer belt 303 transports the cargoes to the warehouse or palletizing position. During loading, the cargoes are transported via the first transfer belt 303 to the receiving component 302 and are lined up by the receiving component 302, and then pushed into the wagon box by means of the movement between the rotating shaft 314 and the telescoping component 312.

In one embodiment, in the unloading mode, the rolling rods 306 rotate toward the second transfer belt 307, the second transfer belt 307 drives toward the first transfer belt 303, and the first transfer belt 303 drives in the same direction as the second transfer belt 307; in the loading mode, the first transfer belt 303 drives toward the second transfer belt 307, the second transfer belt 307 is in the same direction as the first transfer belt 303, and the rolling rods 306 rotate in the direction opposite to the second transfer belt 307.

In the specific implementation, the rolling rods 306, the first transfer belt 303 and the second transfer belt 307 are respectively provided with servo motors to drive the rolling rods 306, the first transfer belt 303 and the second transfer belt 307 for rotation or driving. In the unloading mode, the motion group 30 grips and places the cargoes over the rolling rods 306, the rolling rods 306 rotate toward the second transfer belt 307, the cargoes are transported from the rolling rods 306 to the second transfer belt 307, and then the second transfer belt 307 drives toward the first transfer belt 303 and transports the cargoes to the first transfer belt 303; since the first transfer belt 303 and the second transfer belt 307 are in the same driving direction, the cargoes are moved from the second transfer belt 307 to the first transfer belt 303 and finally transported from the first transfer belt 303 to the warehouse or palletizing position.

In the loading mode, the first transfer belt 303 drives toward the second transfer belt 307, the cargoes are moved from the first transfer belt 303 to the second transfer belt 307, the rolling rods 306 rotate in the direction opposite to the second transfer belt 307, transport and line up the cargoes on the frame body 304, and the cargoes are finally pushed into the wagon box by the adsorption component 311 and the telescoping component 312.

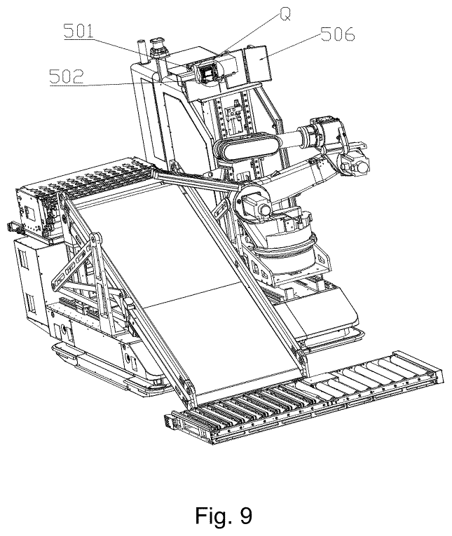

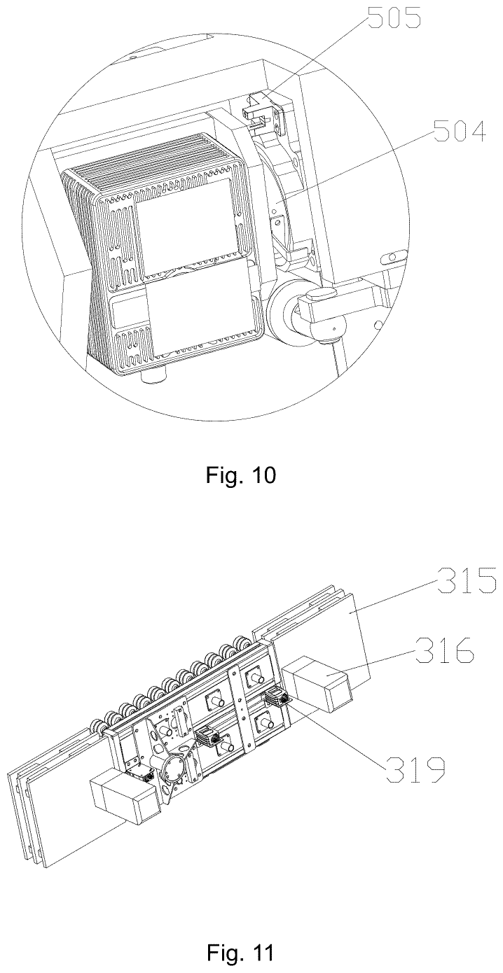

As shown in FIG. 9 and FIG. 10, the visual identification component 50 comprises an image capture component 502 for obtaining the section information of the cargo, an light identification instrument 505 for identifying the external light intensity, a light source controller, a fixing rod 501, a deflection shaft, a first driving component 504 and a plurality of light sources 506, and the first motion component 310 comprises a motion controller; the light identification instrument 505 is arranged on one side of the image capture component 502; the light sources 506 are respectively arranged above the mobile platform 20; the light identification instrument 505 and the light sources 506 are electrically connected with the light source controller; the image capture component 502 is electrically connected with the motion controller; the first driving component 504 and the light identification instrument 505 are fixedly arranged on the fixing rod 501; the image capture component 502 is fixedly arranged on the deflection shaft, and a driving part of the first driving component 504 is fixedly connected with the deflection shaft and drives the deflection shaft and the image capture component 502 to deflect; the light sources 506 are distributed above the mobile platform 20.

In the specific implementation, the image capture component 502 is electrically connected with the motion controller, can identify the cross section of the cargoes in the wagon box and the coordinate position of each cargo in the space, and sends the data to the motion controller; the motion controller controls the first motion component 310 to place the cargoes on the transport group 40 for automatic avoidance, avoid collision between the cargoes when placing the cargoes in the target position. Meanwhile, the visual identification component 50 can judge the size and location information of the cargoes on the transport group 40, and send the data to the first motion component 310, so that the first motion component 310 can accurately reach the pick-up position and pick up the cargo.

More specifically, the image capture component 502 is a 3D camera, which identifies the status of the cargoes in the wagon box, obtains the X-Y-Z coordinate position of each cargo in the space, and sends the position information to the controller of the motion group 30, so that the motion group 30 can accurately grip and place the cargoes in the target position. At the same time, the 3D camera can obtain the size and location information of the incoming cargoes on the transport group 40, and send the data to the motion group 30, so that the motion group 30 can accurately reach the pick-up point and pick up the cargoes.

The intensity of the light sources 506 can be adjusted through the light source controller. More specifically, the light identification instrument 505 identifies the external light intensity and feeds back to the light source controller, and then the light source controller controls the brightness of the light sources 506 according to the external light intensity; the light sources 506 adapts to a variety of light environments and are not limited by time.

More specifically, four light sources 506 are arranged, and the light intensity of the light sources 506 can be automatically adjusted through the controller; at the same time, the light identification instrument 505 can identify the external light intensity and feed back to the light source controller, then the light source controller controls the brightness of the light sources 506 according to the external light intensity, and the light source s 506 realize all-weather lighting and are not susceptible to the influence of external light. The position and orientation of the light sources 506 can be adjusted. In one embodiment, the light source 506 comprises a first intense light source, a second intense light source, a third intense light source and a fourth strong light source, the first intense light source is arranged under the 3D camera, the second intense light source and the third intense light source are arranged on the right side of the 3D camera, and the fourth strong light source is located in front of the first motion component 310. The light sources 506 can achieve all-round lighting, avoid light blind spots, and improve the stability and reliability of the 3D camera.

The first driving component 504 is a servo motor, and the deflection shaft can be driven by the first driving component 504 to deflect up and down and then drives the 3D camera to deflect, expanding the view field of the 3D camera, with a coverage area of 3*1 m (width*height), in order to identify the cargo information in a large range.

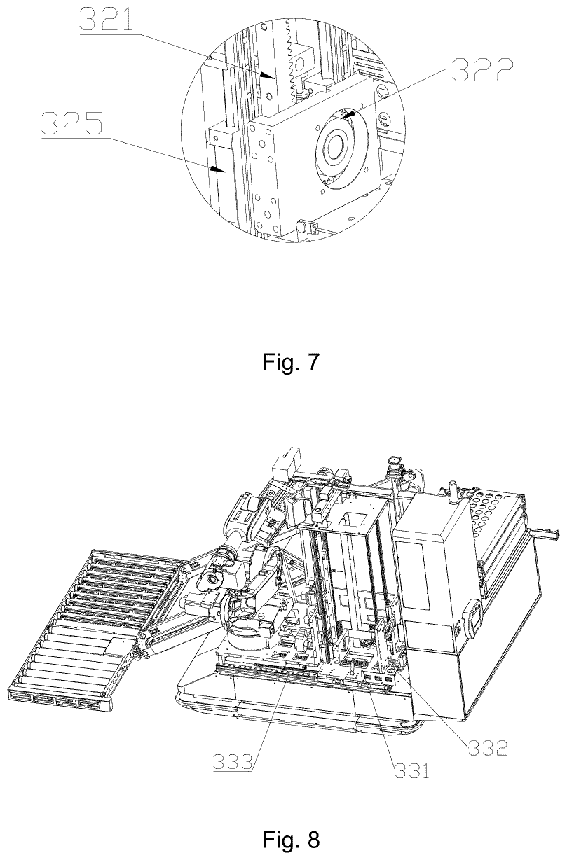

As shown in FIG. 6 and FIG. 7, the second motion component 320 comprises a lifting shaft 321, a first transmission component 322, a carrier rack 323 and a plurality of first guide rails 324, and the rotating seat 313 is arranged on the carrier rack 323; the first transmission component 322 is fixedly connected with the carrier rack 323 and is connected with the lifting shaft 321 in a driving way to drive the rotating seat 313 to displace; the lifting shaft 321 and the first guide rail 324 are vertically placed above the third motion component 330 and are fixedly connected with the third motion component 330; the carrier rack 323 is provided with a sliding block 325 corresponding to the first guide rail 324, and the sliding block 325 is connected with the first guide rail 324 in a sliding way; the first transmission component 322 drives together with the lifting shaft 321, and drives the sliding block 325 to slide along the first guide rail 324.

In the specific implementation, the lifting shaft 321 and the first guide rail 324 are fixedly arranged above the third motion component 330, a rack is arranged on the inner side of the lifting shaft 321, and the first transmission component 322 is a gear, which is meshed with the rack of the lifting shaft 321. The carrier rack 323 and the first transmission component 322 are fixedly arranged, and the rotating seat 313 arranged on the first motion component 310 is fixedly arranged on the carrier rack 323. When the first transmission component 322 displaces vertically along the lifting shaft 321, the carrier rack 323 and the first motion component 310 arranged on the carrier rack 323 also move. A total of four first guide rails 324 are symmetrically arranged on both sides of the lifting shaft 321, and the carrier rack 323 is provided with the sliding blocks 325 corresponding to the first guide rails 324; when the first transmission component 322 drives along the lifting shaft 321, the sliding blocks 325 arranged on the carrier rack 323 slide along the first guide rails 324. A plurality of first guide rails 324 enable steady movement of the carrier rack 323.

As shown in FIG. 8, the third motion component 330 comprises a telescopic shaft 331, a second transmission component 332 and a plurality of second guide rails 333, the telescopic shaft 331 and the second guide rails 333 are respectively arranged under the lifting shaft 321, the second guide rails 333 are fixedly arranged on both sides of the telescopic shaft 331; the second transmission component 332 is fixedly connected with the carrier rack 323, has a driving relation with the telescopic shaft 331 and drives the second motion component 320 and the first motion component 310 to move along the second guide rail 333.

In the specific implementation, two telescopic shafts 331 are arranged and provided with racks, and the racks provided for the two telescopic shafts 331 are opposite; the second transmission component 332 is a gear, which drives with the telescopic shafts 331. The second transmission component 332 is fixed connected with the carrier rack 323; when the second transmission component 332 horizontally displaces along the telescopic shafts 331, the carrier rack 323 also moves, and the first motion component 310 arranged on the carrier rack 323 also moves. The second guide rails 333 are symmetrically arranged on both sides of the telescopic shafts 331, a plurality of sliding blocks corresponding to the second guide rails 333 are arranged at the bottom of the carrier rack 323, and the sliding blocks are respectively provided with chutes. When the second transmission component 332 drives with the telescopic shafts 331, the chutes provided for the sliding blocks move along the second guide rails 333.

As shown in FIG. 11, the telescoping component 312 comprises a plurality of telescoping plates 315 and a second driving component 316, the telescoping plates 315 are symmetrically arranged on both sides of the adsorption component 311, the second driving component 316 and the telescoping plates 315 are arranged correspondingly.

In the specific implementation, the telescoping plates 315 are stacked, and the second driving component 316 is arranged on the bottom telescoping plate 315. The second driving component 316 can be a servo motor or a cylinder. When the second driving component 316 is a servo motor, the telescoping plates 315 can be moved through screw drive or gear rack drive; when the second driving component 316 is a cylinder, the cylinder can be directly driven to make the telescoping plates 315 move. The telescoping component 312 is installed in the loading mode on both sides of the adsorption component 311. After the cargoes are lined up on the receiving component 302, the second driving component 316 is driven to open the telescoping plates 315 and push the cargoes into the wagon box.

As shown in FIG. 3, the adsorption component 311 comprises a plate body 317 and a plurality of adsorption parts 318, the plate body 317 is rotationally connected with the rotating shaft 314, and the adsorption parts 318 are arranged and distributed on a first surface of the plate body 317.

In the specific implementation, the absorption component 318 is a suction cup, and the first surface is the surface of the plate body 317 facing towards the cargoes, and a plurality of suction cups are arranged on the first surface. The suction cups are connected with the plate body 317 in a threaded way. In one embodiment, the suction cups are respectively provided with threads, the plate body 317 is provided with a plurality of threaded holes, and the suction cups are rotated close to the threaded holes arranged on the plate body 317 to fix suction cups on the plate body 317. During unloading, the cargoes are absorbed through a plurality of suction cups provided on the plate body 317 and are placed on the transport group 40 for transport. A plurality of suction cups are arranged to absorb the cargoes, which increases the gripping force on the cargoes and facilitates to place. During loading, the cargoes are lined up on the receiving component 302, and then a plurality of adsorption components and the telescoping plates 315 jointly push the cargoes lined up into the wagon box. In another embodiment, the adsorption component 318 is a vacuum pump or suction nozzle, which is capable of adsorbing the cargoes.

As shown in FIG. 3 and FIG. 4, a plurality of distance measuring components 319 are fixedly arranged on a second surface of the plate body 317, the plate body 317 is also provided with gaps 300, and the distance measuring components 319 are respectively arranged towards the gaps 300.

In the specific implementation, the second surface of the plate body 317 is the back of the plate body 317, and the distance measuring component 319 is a distance measuring instrument, which can measure the distance between the plate body 317 and the cargo; in one embodiment, three distance measuring components 319 are arranged on the back of the plate body 317, the gaps 300 are arranged in the middle of the plate body 317, the distance measuring components 319 are evenly distributed on the back of the plate body 317, measuring ports of the distance measuring components 319 are oriented towards the gaps 300, so that the distance measuring components 319 measure the distance of the cargoes through the gaps 300, and transmit the measured data to the motion controller for calculation in order to accurately grip the cargoes and avoid collisions during gripping.

It should be noted that terms such as “comprising”, “containing” or any other variations herein are intended to cover non-exclusive inclusion, so that a process, method, article or device including a series of elements includes those elements as well as other elements not expressly listed, or includes elements inherent to the process, method, article or device. In the absence of further restrictions, an element defined by the sentence “comprising a” does not exclude the existence of additional identical elements in a process, method, article or device comprising the element.

The above are only the preferred embodiments of the invention, and are not therefore intended to limit the scope of the invention. Any equivalent structure or equivalent process transformation made according to the specification and drawings of the invention, or direct or indirect application in other related technical fields is similarly included in the scope of protection of the invention.

1. An intelligent loading and unloading integrated machine, characterized by comprising a location identification module for identifying container locations, a mobile platform, a motion group, a transport group and a visual identification component for identifying cargo information, the location identification module, the motion group and the transport group are respectively arranged on the mobile platform, and the visual identification component is arranged on one side of the motion group;
the motion group and the transport group work together to take or receive materials;
the transport group comprises a transfer component and a receiving component; a transmission mechanism is arranged between the transfer component and the receiving component to keep the receiving component in a horizontal state;
the motion group comprises a first motion component, a second motion component, a third motion component and a fourth motion component for maintaining a constant distance between the front end of the receiving component and the cargo, and the first motion component, the second motion component, the third motion component and the fourth motion component are linked for gripping the cargo;
the first motion component is arranged on one side of the transport group; the second motion component is fixedly connected with the first motion component, and drives the first motion component to move; the third motion component is fixedly connected with the second motion component, and drives the second motion component to move; the fourth motion component is located below the transport group and drives the transport group to move;
the first motion component comprises an adsorption component, a telescoping component, a rotating seat and a plurality of rotating shafts, and the adsorption component is arranged at one end of the rotating shaft; the telescoping component is detachably connected with the adsorption component; the rotating seat is arranged on the second motion component; the rotating shafts is movably arranged between the rotating seat and the adsorption component.

2. The intelligent loading and unloading integrated machine according to claim 1, characterized by comprising a loading mode and an unloading mode;
in the loading mode, the telescoping component is arranged on both sides of the adsorption component and works with the adsorption component to push the cargo;
in the unloading mode, the adsorption component works with the first motion component to grip the cargo onto the transport group.

3. The intelligent loading and unloading integrated machine according to claim 2, characterized in that the transfer component is linked with the fourth motion component, and is connected with the receiving component through the transmission mechanism; the transfer component is inclined or horizontally arranged above the fourth motion component; the receiving component is arranged horizontally at the front end of the inclined component;
the transfer component comprises a first transfer belt, and the fourth motion component comprises a driving rod, one end of the driving rod is connected with the mobile platform, and the other end thereof is connected with the first transfer belt and drives the first transfer belt to move.

4. The intelligent loading and unloading integrated machine according to claim 3, characterized in that the receiving component comprises a frame body, a wireless detector, a plurality of rolling rods and a second transfer belt, and the rolling rods and the second transfer belt are arranged respectively on the frame body;
the second transfer belt is arranged at the front end of the first transfer belt and has the same motion direction as the first transfer belt; the wireless detector is fixedly arranged on one side of the frame body for detecting the cargo; the rolling direction of the rolling rods is perpendicular to the second transfer belt.

5. The intelligent loading and unloading integrated machine according to claim 4, characterized in that in the unloading mode, the rolling rods rotate toward the second transfer belt, the second transfer belt drives toward the first transfer belt, and the first transfer belt has the same driving direction as the second transfer belt;
in the loading mode, the first transfer belt drives toward the second transfer belt, the second transfer belt has the same driving direction as the first transfer belt, and the rolling rods rotate in the direction opposite to the second transfer belt.

6. The intelligent loading and unloading integrated machine according to claim 1, characterized in that the visual identification component comprises an image capture component for obtaining the section information of the cargo, an light identification instrument for identifying the external light intensity, a light source controller, a fixing rod, a deflection shaft, a first driving component and a plurality of light sources, and the first motion component comprises a motion controller;
the light identification instrument is arranged on one side of the image capture component; the light sources are respectively arranged above the mobile platform; the light identification instrument and the light sources are electrically connected with the light source controller; the image capture component is electrically connected with the motion controller;
the fixing rod is fixedly arranged above the second motion component, and the first driving component is fixedly arranged on the fixing rod; the image capture component is fixedly arranged on the deflection shaft, and a driving part of the first driving component is fixedly connected with the deflection shaft and drives the deflection shaft and the image capture component to deflect.

7. The intelligent loading and unloading integrated machine according to claim 1, characterized in that the second motion component comprises a lifting shaft, a first transmission component, a carrier rack and a plurality of first guide rails, and the rotating seat is arranged on the carrier rack; the first transmission component is fixedly connected with the carrier rack and is connected with the lifting shaft in a driving way to drive the rotating seat to move; the lifting shaft and the first guide rail are vertically placed above the third motion component and are fixedly connected with the third motion component;
the carrier rack is provided with a sliding block corresponding to the first guide rail, and the sliding block is connected with the first guide rail in a sliding way; the first transmission component drives together with the lifting shaft, and drives the sliding block to slide along the first guide rail.

8. The intelligent loading and unloading integrated machine according to claim 7, characterized in that the third motion component comprises a telescopic shaft, a second transmission component and a plurality of second guide rails, the telescopic shaft and the second guide rails are respectively arranged under the lifting shaft, the second guide rails are fixedly arranged on both sides of the telescopic shaft; the second transmission component is fixedly connected with the carrier rack and has a driving relation with the telescopic shaft to drive the second motion component and the first motion component to move along the second guide rail.

9. The intelligent loading and unloading integrated machine according to claim 1, characterized in that the telescoping component comprises a plurality of telescoping plates and a second driving component, the telescoping plates are symmetrically arranged on both sides of the adsorption component, the second driving component and the telescoping plates are arranged correspondingly.

10. The intelligent loading and unloading integrated machine according to claim 1, characterized in that the adsorption component comprises a plate body and a plurality of adsorption parts, the plate body is rotationally connected with the rotating shaft, and the adsorption parts are arranged and distributed on a first surface of the plate body.

11. The intelligent loading and unloading integrated machine according to claim 10, characterized in that a plurality of distance measuring components are fixedly arranged on a second surface of the plate body, the plate body is also provided with gaps, and the distance measuring components are respectively arranged towards the gaps.
